(19) United States
(12) Patent Application Publication
(10) Pub. No.: US 2013/0177666 A1
(43) Pub. Date: Jul. 11, 2013

(54) Mold-Tool System Including Air Cavity Circuit, and Means for Forcing Relatively Cooler Air Stream to Air Cavity Circuit

(71) Applicants: Gregory Ray Hammond, Georgetown (CA); Troy Richard Mercer, Milton, VT (US)

(72) Inventors: Gregory Ray Hammond, Georgetown (CA); Troy Richard Mercer, Milton, VT (US)

(73) Assignee: HUSKY INJECTION MOLDING SYSTEMS LTD., Bolton, ON (CA)

(21) Appl. No.: 13/825,562

(22) PCT Filed: Oct. 10, 2011
(86) PCT No.: PCT/US11/55555

§ 371 Date: Mar. 22, 2013

Related U.S. Application Data
(60) Provisional application No. 61/407,058, filed on Oct. 27, 2010.

(51) Int. Cl. B29C 45/72

(52) U.S. Cl. CPC B29C 45/72
USPC 425/547

(57) ABSTRACT

A mold-tool system (100), comprising: (i) a hot runner manifold assembly (102), (ii) a plate assembly (104) defining an air-cavity circuit (106), the plate assembly (104) being configured to support and surround, at least in part, the hot runner manifold assembly (102), and the air-cavity circuit (106) surrounding, at least in part, the hot runner manifold assembly (102); and (iii) means for forcing, in use, a relatively cooler air stream to the air-cavity circuit (106), wherein that the air-cavity circuit (106) is configured to: (i) increase, in use, thermal losses of the hot runner manifold assembly (102), and (ii) reduce time to cool down the hot runner manifold assembly (102) relative to heat lost as a result of natural convection associated with the hot runner manifold assembly (102).

### TECHNICAL FIELD

An aspect generally relates to (but is not limited to) mold-tool systems including (but not limited to) an air-cavity circuit, and means for forcing relatively cooler air stream to the air-cavity circuit.

### BACKGROUND

U.S. Pat. No. 5,533,882 discloses (with reference to FIG. 5 of U.S. Pat. No. 5,533,882) means for maintaining means for reciprocating in a cooled state include cooling channels. The cooling channels are placed between the mold manifold plate and sleeve. Accordingly, at various points along the length of nozzle housing, a coolant is introduced into a port through a channel and into an annular space between mold manifold plate and sleeve. The fluid is removed from the other side of nozzle housing through channel. In this manner, a more direct cooling of seals can be achieved.

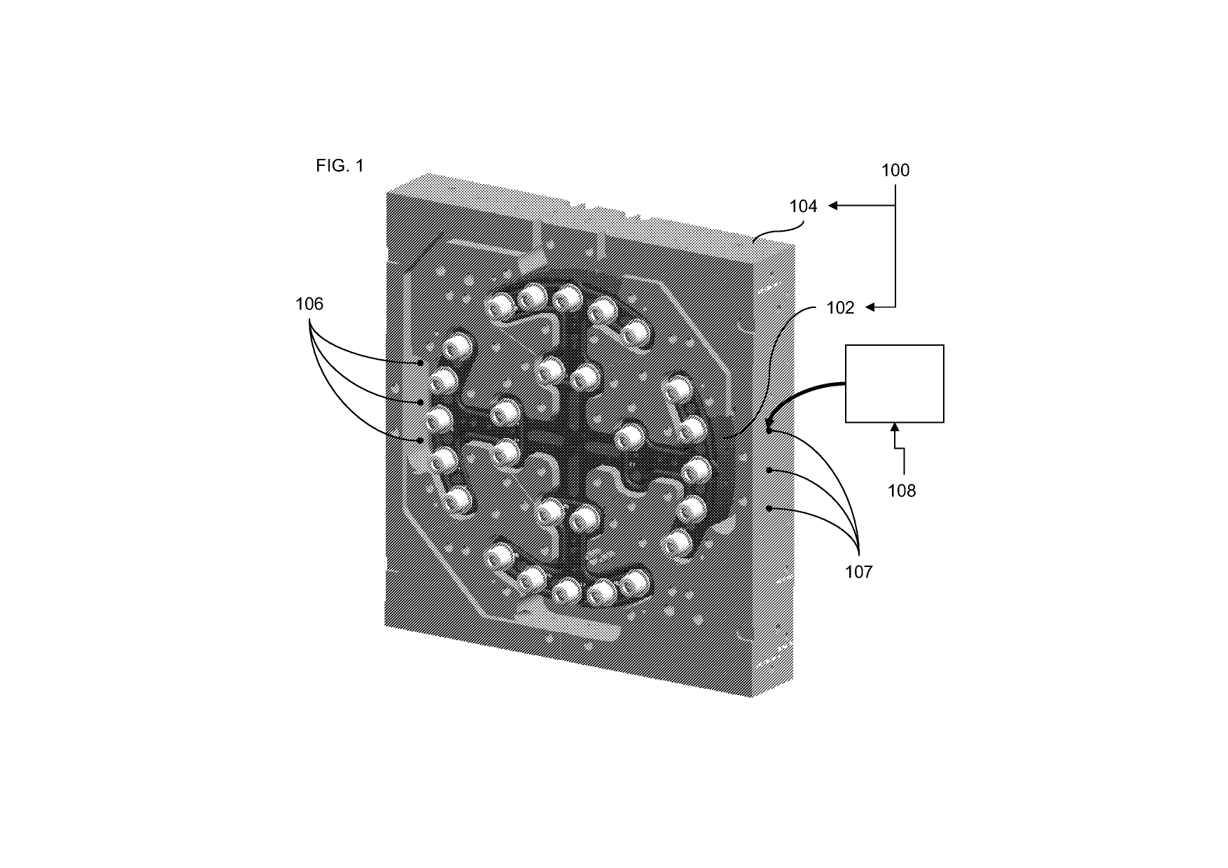

United States Patent Publication Number 2006/0017199 discloses (with reference to FIG. 1 of Publication Number 2006/0017199) a portion of a coinjection hot runner assembly and mold that includes, in part, a first hot runner manifold, a second hot runner manifold, a nozzle housing, a cooled manifold plate, a shooting pot cylinder, a shooting pot piston, a heat-sink sleeve, a retaining ring, and a spring. The hot runner manifolds are heated by heaters, and the manifold plate is cooled by coolant flowing through cooling channels.

U.S. Pat. No. 7,287,977 discloses a manifold system wherein the air plate has a plurality of cooling channels for conducting fluid, in use, to cool the air plate. Between the manifold plate and the backing plate there is an air plate that has a plurality of actuator cavities for nozzle actuators as well as a plurality of air channels that conduct actuating fluid, such as air, to the actuators. The air plate also preferably has a plurality of cooling channels for conducting cooling fluid, in use, to cool the air plate. Air plate preferably has cooling channels that, in use, conduct cooling fluid, such as water, through air plate, preferably proximate to actuator cavities so that air plate is sufficiently cool to prevent seal degradation for actuators in actuator cavities. Cooling of air plate also enhances thermal isolation between main manifold and sub-manifolds, which minimizes thermal variation in sub-manifold and improves the material flow balance in the system. Cooling channels are aligned with and communicate with cooling ports in air plate, which are aligned with and communicate with cooling ports in manifold plate and cooling ports in backing plate. Cooling ports may be arranged to align with and communicate with cooling ports in a platen of an injection molding machine in which manifold system can be installed. Preferably o-rings, or similar types of seals, are used to provide sealing between adjacent plate faces at interfaces of cooling ports. Such arrangement of cooling lines and ports in the plates eliminate the need for any cooling fluid hoses to be attached directly to the manifold system. Cooling fluid is received directly from the platen, to which cooling fluid hoses are attached. This reduces the time necessary to remove manifold system from the injection molding machine since there are no hoses or hose fittings to disconnect from the manifold system. The additional space also allows for insertion of an air plate that provides all the air for valve gate actuators as well as cooling fluid to better thermally isolate the main manifold from the sub-manifolds and to simplify installation and removal of the manifold system from an injection molding machine.

European Patent Number 0444455 discloses a hot runner manifold with a cooling circuit inside the manifold, to quickly cool down the manifold after it is shut off the minimize resin degradation.

U.S. Pat. No. 2,508,988 discloses a heated melt conveying tube has a cooling air jacket surrounding the heaters so that temperature override can be limited by accelerating the cooling of the heaters by the introduction of cold air. Control is conventional with thermocouples etc.

U.S. Pat. No. 5,007,821 discloses a manifold that has two cooling channels drilled alongside the melt channel including a spiral vane to induce turbulent air cooling to hasten mold shut down without resin degradation.

### SUMMARY

The inventors have researched a problem associated with known molding systems that inadvertently manufacture bad-quality molded articles or parts. After much study, the inventors believe they have arrived at an understanding of the problem and its solution, which are stated below, and the inventors believe this understanding is not known to the public, which is as follows: long cool down time of a hot runner system may be required to solidify a resin before allowing a mold cavity plate to be latched over for servicing and mold exchange. Unsafe latching over of mold cavity plate before resin should be avoided.

According to one aspect, there is provided a mold-tool system (100), comprising: (i) a hot runner manifold assembly (102); (ii) a plate assembly (104) defining an air-cavity circuit (106), the runner plate assembly (104) being configured to support and surround, at least in part, the hot runner manifold assembly (102), and the air-cavity circuit surrounding, at least in part, the hot runner manifold assembly; and (iii) means for forcing, in use, a relatively cooler air stream to the air-cavity circuit. Wherein the air-cavity circuit (106) is configured to: (i) increase, in use, thermal losses of the hot runner manifold assembly (102), and (ii) reduce time to cool down the hot runner manifold assembly (102) relative to heat lost as a result of natural convection associated with the hot runner manifold assembly (102).

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

FIG. 1 depicts a schematic representation of a mold-tool system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

Specifically, FIG. 1 depicts a perspective view of the mold-tool system (100). The mold-tool system (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

The mold-tool system (100) may include (and is not limited to): (ii) a hot runner manifold assembly (102), (ii) a plate assembly (104), and (ii) means for forcing (108). The plate assembly (104) defines an air-cavity circuit (106). The plate assembly (104) is configured to support and surround, at least in part, the hot runner manifold assembly (102). The air-cavity circuit (106) surrounds, at least in part, the hot runner manifold assembly (102). The means for forcing (108) is configured to force, in use, a relatively cooler air stream to the air-cavity circuit (106). The air-cavity circuit (106) is configured to: (i) increase, in use, thermal losses of the hot runner manifold assembly (102), and (ii) reduce time to cool down the hot runner manifold assembly (102) relative to heat lost as a result of natural convection associated with the hot runner manifold assembly (102).

A possible technical advantage associated with the mold-tool system (100) is allowance for less time before a cavity plate latch over may be performed, and thus saves time for users of the mold-tool system (100) who change molds on hot runners relatively frequently.

The forced air may be compressed air that is supplied through an interface (107) such as a hose, etc. The hoses may be attached to holes located on a side of the plate assembly (104) that lead to the air-cavity circuit (106) surrounding the hot runner manifold assembly (102).

The means for forcing (108) may be, for example, a dehumidification unit (not depicted but known), which is an assembly that may already be used in a molding system for conditioning air a molding area. The means for forcing (108) may be, by way of another example, a fan system, etc.

It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising”. It is noted that the foregoing has outlined the non-limiting embodiments (examples). The description is made for particular non-limiting embodiments (examples). It is understood that the non-limiting embodiments are merely illustrative as examples.

What is claimed is:

1. A mold-tool system (100), comprising:
a hot runner manifold assembly (102);
a plate assembly (104) defining an air-cavity circuit (106), the plate assembly (104) being configured to support and surround, at least in part, the hot runner manifold assembly (102), and the air-cavity circuit (106) surrounding, at least in part, the hot runner manifold assembly (102); and
means for forcing being configured to force, in use, a relatively cooler air stream to the air-cavity circuit (106),
wherein the air-cavity circuit (106) is configured to: (i) increase, in use, thermal losses of the hot runner manifold assembly (102), and (ii) reduce time to cool down the hot runner manifold assembly (102) relative to heat lost as a result of natural convection associated with the hot runner manifold assembly (102).
